(19) United States
(12) Patent Application Publication
(10) Pub. No.: US 2004/0184108 A1
(43) Pub. Date: Sep. 23, 2004

(54) Multi-function peripheral system, multi-function peripheral apparatus, option image display unit, image information processing method, and image information processing program

(75) Inventor: Kenji Takano, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/370,493

(22) Filed: Feb. 24, 2003

(51) Int. Cl. H04N 1/00

(52) U.S. Cl. 358/400

(57) ABSTRACT

The present invention provides a multi-function peripheral system, a multi-function peripheral apparatus, an option image display unit, an image information processing method, and an image information processing program, which allow a reduction in the capacity required for an image information storage unit provided on the option image display unit side in a multi-function peripheral system that can be additionally equipped with an option panel according to need.

A multi-function peripheral system has an MFP main body 19 with a standard panel 9 for performing image display, and an option image display unit 12 for performing image display that is capable of being detachably attached to the MFP main body 19. The system has an HDD 1 provided outside the option image display unit to store at least image information to be used for image display on the option image display unit 12. The option image display unit 12 has an option panel for performing image display and a CPU 13 for controlling the option panel to perform image display based on the image information stored in the HDD 1.

### BACKGROUND OF THE INVENTION

1. Field of the Invention

The present invention relates to a multi-function peripheral system, a multi-function peripheral apparatus, an option image display unit, an image information processing method, and an image information processing program.

2. Description of the Related Art

There has heretofore been provided an MFP (Multi-Function Peripheral) that can be additionally equipped with an option panel with a special-purpose controller in addition to a standard panel, which is provided on the MFP main body, for the purpose of improving the operability of the operation control part of the apparatus. Such option panels (option image display units) include one that is capable of color display on a large screen.

In the MFP, the required display data capacity for the standard panel provided on the MFP main body (in the case, for example, of a monochrome 1/4VGA display panel) is as follows:

320×240/8=9.6 KB (per frame)

In actuality, the MFP has 128 KB for the UI (User Interface) hierarchy as display data per language. UI data in a default language selected as an initial display language is stored in an FROM provided in the MFP main body, and UI data in other languages is stored in an HDD provided in the MFP main body. The control of downloading UI data from the HDD to the FROM, which is executed in response, for example, to the setting for switching the default language (i.e. changing it to another language) by a user's operation, is performed in the MFP main body. Thus, the minimum required capacity of the FROM, which is higher in capacity unit cost than the HDD, can be reduced, thereby achieving a cost reduction.

On the other hand, the required display data capacity for a large-screen/color display option panel that can be added to the MFP main body, for example, a 256-shade (8-bit) full-VGA (640×480) display panel, is as follows:

8×640×480/8=307 KB (per frame)

It should be noted that an image to be displayed on the screen is, actually, expanded by a drawing function provided by a program, and image information needs to be expressed in terms of program capacity instead of being dot information. However, it is herein expressed in the form of dot information for the sake of simplicity.

Examples of such a multi-function peripheral system are disclosed in Japanese Patent Application Unexamined Publication (KOKAI) Nos. Hei 6-253084 and 2002-23718.

The conventional multi-function peripheral apparatus arranged as stated above needs an amount of dot information or expandable image information as much as that required for a plurality of frames and languages switchable from one to another in order to allow screen display on the option panel. In the above-described prior art, the necessary information is stored in an FROM provided on the option panel side. However, because the amount of data to be stored is enormous, if all the data is stored in the FROM provided on the option panel side, the capacity required for the FROM, which has a high capacity unit cost, increases unfavorably. Consequently, a cost reduction cannot be attained. There has also been known an arrangement in which an FROM and an HDD are incorporated in the option panel as in the case of the MFP main body, and necessary information is downloaded from the HDD to the FROM as occasion demands, thereby reducing the capacity required for the FROM. In this case, an HDD needs to be provided on the option panel side. This obstructs the reduction in size of the option panel and simplification thereof, and it is also difficult to achieve a satisfactory cost reduction.

### SUMMARY OF THE INVENTION

The present invention was made to solve the above-described problems. Accordingly, an object of the present invention is to provide a multi-function peripheral system, a multi-function peripheral apparatus, an option image display unit, an image information processing method, and an image information processing program, which allow a reduction in the capacity required for an image information storage unit provided on the option image display unit side in a multi-function peripheral system that can be additionally equipped with an option panel according to need.

To solve the above-described problem, the present invention provides a multi-function peripheral system having a multi-function peripheral main body with a main body-side image display unit for performing image display. The multi-function peripheral system further has an option image display unit for performing image display that is capable of being detachably attached to the multi-function peripheral main body. An image information storage unit is provided outside the option image display unit to store at least image information to be used for image display on the option image display unit. The option image display unit has an option-side image display unit for performing image display and a control unit for controlling the option-side image display unit to perform image display based on the image information stored in the image information storage unit.

With the above-described arrangement, even in the case of performing image display on the option image display unit based on an enormous amount of UI data (data serving as image information) for a plurality of languages, a storage area of large capacity need not be provided on the option image display unit side because the UI data can be stored in the image information storage unit provided outside the option image display unit. Further, even when a storage area is needed on the option image display unit side, it is only necessary to provide a storage area (e.g. an FROM) having a minimum required capacity. Thus, the arrangement according to the present invention has the effect of achieving a cost reduction.

Consequently, it is possible to reduce the required capacity of an FROM provided on the option image display unit side in a multi-function peripheral apparatus that can be additionally equipped with an option image display unit according to need.

Further, it is desirable that the above-described option image display unit should have an option-side storage unit for storing some information obtained from information stored in the image information storage unit and displayable by the option image display unit. If the system is arranged to obtain only minimum required information from the image information stored in the image information storage unit and to store it in the option-side storage unit as stated above, the option-side storage unit need not be of large storage capacity (i.e. of high cost).

It should be noted that the above-described image information storage unit desirably stores image information to be used for image display on the main body-side image display unit. With this arrangement, image information to be used for image display on the main body-side image display unit and image information to be used for image display on the option-side image display unit are stored in the same storage area. More specifically, the arrangement may be such that a storage area, e.g. a hard disk, stores image information to be used for image display on the main body-side image display unit, and a free area of the hard disk stores image information to be used for image display on the option-side image display unit. By storing the image information for the two image display units in the same storage area as stated above, it is possible to reduce the costs and simplify the arrangement in comparison to the arrangement in which a storage area for image information is provided for each of the two image display units.

It is desirable that the above-described image information storage unit should be provided in the multi-function peripheral main body. More specifically, a large-capacity storage area, e.g. a hard disk, contained in the multi-function peripheral main body may be used as the image information storage unit. It should be noted that the option-side storage unit may comprise an FROM.

To solve the above-described problem, the present invention provides a multi-function peripheral apparatus having a main body-side image display unit for performing image display and capable of being detachably equipped with an option image display unit for performing image display. The multi-function peripheral apparatus has an image information storage unit for storing at least image information usable for image display on the option image display unit, and a main body-side control unit for transmitting image information concerning a selected part of the image information stored in the image information storage unit to the option image display unit.

With the above-described arrangement, even in the case of performing image display on the option image display unit based on an enormous amount of UI data (data serving as image information) for a plurality of languages, a storage area of large capacity need not be provided on the option image display unit side because the UI data can be stored in the image information storage unit provided outside the option image display unit. Further, even when a storage area is needed on the option image display unit side, it is only necessary to provide a storage area (e.g. an FROM) having a minimum required capacity. Thus, the arrangement according to the present invention has the effect of achieving a cost reduction.

Consequently, it is possible to reduce the required capacity of a storage area, e.g. an FROM, provided on the option image display unit side in a multi-function peripheral apparatus that can be additionally equipped with an option image display unit according to need.

It should be noted that the above-described image information storage unit desirably stores image information to be used for image display on the main body-side image display unit, as has been stated above. With this arrangement, it is possible to obtain the same advantageous effect as the above.

To solve the above-described problem, the present invention provides an option image display unit for performing image display that is capable of being detachably attached to a multi-function peripheral main body having a main body-side image display unit for performing image display. The option image display unit has an option-side image display unit for performing image display, and a control unit for controlling the option-side image display unit to perform image display based the image information stored in an image information storage unit provided outside the option image display unit.

With the above-described arrangement, even in the case of performing image display on the option image display unit based on an enormous amount of UI data (data serving as image information) for a plurality of languages, a storage area of large capacity need not be provided on the option image display unit side because the UI data can be stored in the image information storage unit provided outside the option image display unit. Further, even when a storage area is needed on the option image display unit side, it is only necessary to provide a storage area (e.g. an FROM) having a minimum required capacity. Thus, the arrangement according to the present invention has the effect of achieving a cost reduction.

Consequently, it is possible to reduce the required capacity of an FROM provided on the option image display unit side in a multi-function peripheral apparatus that can be additionally equipped with an option image display unit according to need.

Further, it is desirable that the above-described option image display unit should have an option-side storage unit for storing some information obtained from information stored in the image information storage unit and displayable by the option image display unit. It is preferable to use an FROM or the like as the option-side storage unit.

It should be noted that the above-described image information storage unit desirably stores image information to be used for image display on the main body-side image display unit, as has been stated above. With this arrangement, it is possible to obtain the same advantageous effect as the above.

It is desirable that the above-described image information storage unit should be provided in the multi-function peripheral main body. More specifically, a large-capacity storage area, e.g. a hard disk, contained in the multi-function peripheral main body may be used as the image information storage unit.

Further, the above-described image information storage unit may be provided in an external device connected to the multi-function peripheral main body through a network. If the system is arranged to be capable of using the storage area of an external device connected through a network as stated above, it is possible to use an enormous amount of image information that cannot be stored in a storage area contained in the multi-function peripheral main body.

It is a matter of course that the image information stored in the above-described image information storage unit can be changed and updated through a network.

To solve the above-described problem, the present invention provides an image information processing method for processing image information in a multi-function peripheral apparatus including a multi-function peripheral main body having a main body-side image display unit for performing image display. The multi-function peripheral apparatus further includes an option image display unit for performing image display that is capable of being detachably attached to the multi-function peripheral main body. The image information processing method has an image information selectively designating step of selectively designating some image information to be used in the option image display unit from an image information storage unit for storing at least image information usable for image display on the option image display unit; a read step of reading the image information selectively designated by the image information selectively designating step; and a step of transmitting the image information read in the read step to the option image display unit.

In addition, the present invention provides an image information processing method for processing image information in a multi-function peripheral main body having a main body-side image display unit for performing image display and capable of being detachably equipped with an option image display unit for performing image display. The image information processing method has a read step of reading image information from an image information storage unit for storing at least image information to be used for image display on the option image display unit; and a step of transmitting the image information read in the read step to the option image display unit.

In addition, the present invention provides an image information processing method for processing image information in an option image display unit for performing image display that is capable of being detachably attached to a multi-function peripheral main body having a main body-side image display unit for performing image display. The image information processing method has a step of reading image information stored in an image information storage unit provided outside the option image display unit, and a step of allowing an option-side image display unit to perform image display based on the image information read in the read step.

To solve the above-described problem, the present invention provides an image information processing program executable by a computer for processing image information in a multi-function peripheral apparatus including a multi-function peripheral main body having a main body-side image display unit for performing image display. The multi-function peripheral apparatus further includes an option image display unit for performing image display that is capable of being detachably attached to the multi-function peripheral main body. The image information processing program has an image information selectively designating step of selectively designating some image information to be used in the option image display unit from an image information storage unit for storing at least image information usable for image display on the option image display unit; a read step of reading the image information selectively designated by the image information selectively designating step; and a step of transmitting the image information read in the read step to the option image display unit. The above-described steps are executed by the computer.

In addition, the present invention provides an image information processing program for processing image information in a multi-function peripheral main body having a main body-side image display unit for performing image display and capable of being detachably equipped with an option image display unit for performing image display. The image information processing program has a read step of reading image information from an image information storage unit for storing at least image information to be used for image display on the option image display unit; and a step of transmitting the image information read in the read step to the option image display unit. The program instructs a computer to execute the above-described steps.

In addition, the present invention provides an image information processing program for processing image information in an option image display unit for performing image display that is capable of being detachably attached to a multi-function peripheral main body having a main body-side image display unit for performing image display. The image information processing program has a step of reading image information stored in an image information storage unit provided outside the option image display unit, and a step of allowing an option-side image display unit to perform image display based on the image information read in the read step. The program instructs a computer to execute the above-described steps.

### DESCRIPTION OF THE DRAWINGS

FIG. 1 is a functional block diagram for describing a multi-function peripheral system according to an embodiment of the present invention.

FIGS. 2(A) and 2(B) are diagrams showing screen display on a standard panel in the multi-function peripheral system according to the embodiment of the present invention.

FIGS. 3(A) and 3(B) are diagrams showing screen display on the standard panel in the multi-function peripheral system according to the embodiment of the present invention.

FIGS. 4(A) and 4(B) are diagrams showing screen display on the standard panel and an option panel in the multi-function peripheral system according to the embodiment of the present invention.

FIG. 5 is a flowchart for describing a method of temporarily changing display languages used on the option panel.

FIGS. 6(A) to 6(E) are diagrams for describing the method of temporarily changing display languages used on the option panel.

FIG. 7 is a flowchart for describing a method of changing a default language used on the option panel.

FIGS. 8(A) to 8(C) are diagrams for describing the method of changing a default language used on the option panel.

### DESCRIPTION OF THE PREFERRED EMBODIMENTS

A multi-function peripheral system, a multi-function peripheral apparatus, an option image display unit, an image information processing method and an image information processing program according to embodiments of the present invention will be described below with reference to the accompanying drawings.

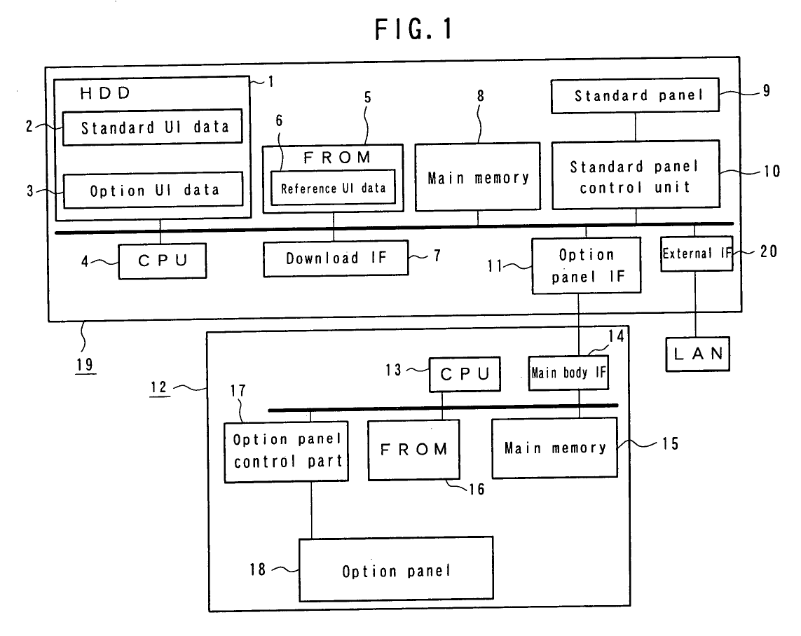

FIG. 1 is a functional block diagram for describing a multi-function peripheral system according to an embodiment of the present invention. The system has a multi-function peripheral (hereinafter abbreviated as “MFP”) main body 19 and an option image display unit 12 capable of being detachably attached to the MFP main body 19. Thus, the system is capable of performing screen display by an option panel (option-side image display unit) 18 of the option image display unit 12 in addition to screen display by a standard panel (main body-side image display unit) 9 of the MFP main body 19. FIG. 1 shows the arrangement of the MFP main body having a standard panel and the arrangement of an option image display unit.

First, the MFP main body 19 will be described. The MFP main body 19 comprises an HDD 1, a CPU 4, an FROM 5, a main memory 8, a standard panel 9, a standard panel control unit 10, a download IF 7, an option panel IF 11, and an external IF 20. The standard panel control unit 10 has the functions of generating image data to be displayed on the standard panel 9 and transferring the generated image data to the standard panel 9. Image data generated in the standard panel control unit 10 is based on reference UI data stored in the FROM 5 (the reference UI data will be described later) and an operation menu program and machine management information managed by the CPU 4 (main body-side control unit), etc. The display screen transition is supervised by the CPU 4. Each screen is displayed in response to a user's operation.

The CPU 4 supervises control operations at the MFP main body 19 and has the functions of giving instructions to the standard panel control unit 10 and controlling communication with the option image display unit 12. The CPU 4 further has the functions of performing data transfer with the option image display unit 12 and managing communication control software for controlling communication with an external device through the external IF 20. Programs necessary for control operations at the MFP main body 19 are stored in the FROM 5. The main memory 8 is used as a work area for executing the programs stored in the FROM 5.

In the MFP main body 19, the HDD (image information storage unit) 1 stores print data, copy image data, FAX image data, etc. for performing an image forming operation, e.g. printing, by an image forming unit (not shown). The HDD 1 also stores standard UI data 2 and option UI data 3 separately from the above-mentioned data. These UI data items serve as image information.

The standard UI data 2 includes hierarchical screen data for allowing the standard panel 9 to display screens with a hierarchical structure. The standard UI data 2 further includes HELP screen data, abnormality display data, and various language data as font data for messages to be displayed superimposed on the above-mentioned data.

The option UI data 3 includes hierarchical screen data for displaying screens with a hierarchical structure on the option panel 18 of the option image display unit 12. The option UI data 3 further includes HELP screen data, abnormality display data, and various language data as font data for messages to be displayed superimposed on the above-mentioned data.

The standard UI data 2 and the option UI data 3 stored in the HDD 1 of the MFP main body 19 can be updated/installed through the download IF 7. The CPU 4 transfers data downloaded through the download IF 7 to the HDD 1.

The arrangement also-allows updating/installation of data through the external IF 20 (via network connection) in place of the download IF 7. Such installation function through the external IF 20 is realized by a combination of the CPU 4 and the external IF 20 having protocols such as TCP/IP, which enables access to the Internet, and FTP, which allows file transfer.

It is a matter of course that the use of the above-described function makes it possible to place the image information storage unit for storing the standard UI data 2 and the option UI data 3 in a server or the like (external device) outside the system, which is connected to the MFP main body 19 through a network, instead of using the HDD 1 provided in the MFP main body 19. If it is made possible to use the storage area of an external device connected through a network by the described arrangement, it is possible to use an enormous amount of image information that cannot be stored in a storage area contained in the multi-function peripheral main body.

The system in this embodiment is arranged such that when it is detected that the option image display unit 12 has been attached to the MFP main body 19, the option UI data 3 stored in the HDD 1 is transferred to an FROM (option-side storage unit) provided in the option image display unit 12.

It should be noted that this embodiment uses an storage area in the HDD 1 to store the standard UI data 2 and the option UI data 3, as stated above. In the present invention, option UI data, which has heretofore been stored in a storage area in the option image display unit, is stored in a storage area outside the option image display unit (i.e. a free area of the HDD 1 in this embodiment), thereby allowing the system to use a desired amount of option UI data without being restricted to the free available capacity of the storage area in the option image display unit. It is also possible to reduce the storage area of an FROM or the like provided in the option image display unit. In other words, by storing the image information for the MFP main body 19 and the option image display unit 12 in the same storage area, it is possible to reduce the costs and simplify the arrangement in comparison to the arrangement in which a storage area for image information is provided for each of them.

Here, the above-mentioned reference UI data 6 will be described in detail. The reference UI data 6 stored in the FROM 5 is UI data concerning some languages previously selected from the standard UI data 2, which is UI data concerning a plurality of languages, and stored in the FROM 5. Setting for selection of the reference UI data 6 from the standard UI data 2 is performed by serviceman setting or destination setting at the time of shipment of the system. By the setting operation, necessary UI data is selected from the standard UI data 2 and transferred to and stored in the FROM 5.

This arrangement allows minimization of the amount of UI data to be stored as standard in the FROM 5 of the MFP main body 19. UI data corresponding to other language specifications, etc. is stored as the standard UI data 2 in the storage area of the HDD 1.

Next, the option image display unit 12 will be described. The option image display unit 12 comprises a CPU 13, a main body IF 14, an FROM 16, a main memory 15, an option panel control unit 17, and an option panel 18. The CPU 13 (control unit) for controlling the whole option image display unit is provided in the option image display unit 12 as in the case of the MFP main body 19. Display data for displaying an image on the option panel 18 is generated by the option panel control unit 17 and transferred to the option panel 18.

The FROM 16 stores programs used for control operations at the option image display unit 12. The main memory 15 is used as a work memory for executing the programs stored in the FROM 16.

Image display data used in the option image display unit 12 is transferred from the MFP main body 19 through the option panel IF 11 contained in the MFP main body 19 and further through the main body IF 14. Of the image display data transferred, UI data is selected from the option UI data 3 stored in the HDD 1 of the MFP main body 19 and transferred.

The control of the data transfer at this time is performed by inter-CPU communication between the CPU 4 of the MFP main body 19 and the CPU 13 of the option image display unit. The data transferred to the option image display unit 12 is stored in the FROM 16 and referenced by the CPU 13 as UI data. More specifically, the CPU 4 has the function of transmitting image information stored in the HDD 1 (image information storage unit) to the option image display unit 12 by using the option panel IF 11. The CPU 13 has the function of temporarily taking image information into the option image display unit from the image information storage unit provided outside the option image display unit and storing image information. The CPU 13 further has the function of displaying an image on the option-side image display unit based on the image information taken in.

Data transferred to the option image display unit 12 in this case is not all of the option UI data 3 stored in the HDD 1 of the MFP main body 19 but a part of UI data previously designated on the basis of serviceman setting or destination setting at the time of shipment of the system as in the case of the reference UI data 6 used in the MFP main body 19. It should be noted that the method of changing a default language used on the option panel 18 will be described later.

With the above-described arrangement, the amount of data transferred from the MFP main body 19 to the option image display unit 12 is minimized, and thus the required capacity of the FROM 16 is minimized. Further, because the free available capacity of the HDD 1 in the MFP main body 19 is used to store the whole option UI data 3 and only a necessary amount of data is transferred to the option image display unit as occasion demands, a large-capacity memory, e.g. an HDD, need not be provided in the option image display unit 12.

It should be noted that the standard UI data 2 and the option UI data 3 are independent of each other. That is, the standard UI data 2 and the option UI data 3 contain no piece of data that is mutually referenced.

Thus, the multi-function peripheral system according to the embodiment of the present invention has an image information storage unit provided outside the option image display unit and adapted to store at least image information to be used for image display on the option image display unit. The option image display unit has an option-side image display unit for performing image display and a control unit for controlling the option-side image display unit to perform image display based on the image information stored in the image information storage unit.

Specifically, the standard panel 9 in this embodiment is a monochrome binary (only ON/OFF) 1/2VGA (640×240 dots) display panel. A screen displayed in a standby state has a default screen corresponding to each function (copy, PRT, FAX, and scanner). When the user wants to use a specific function displayed in the screen, he or she selects an icon representing the desired function.

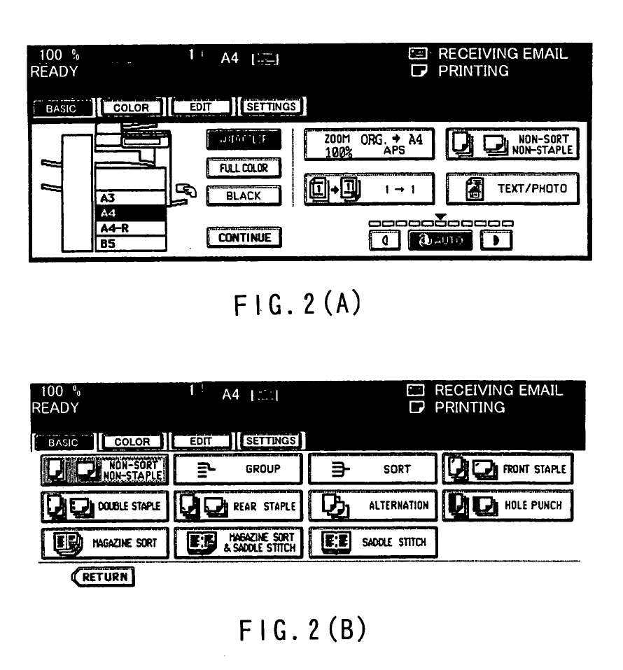

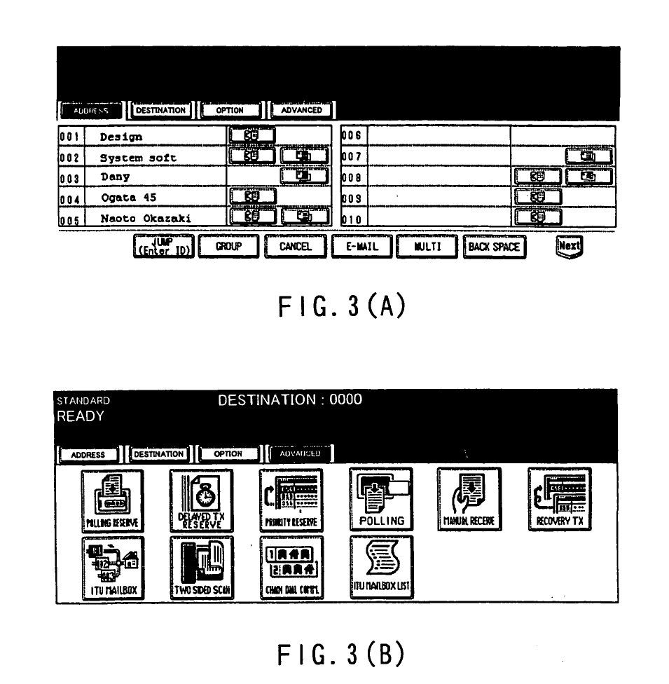

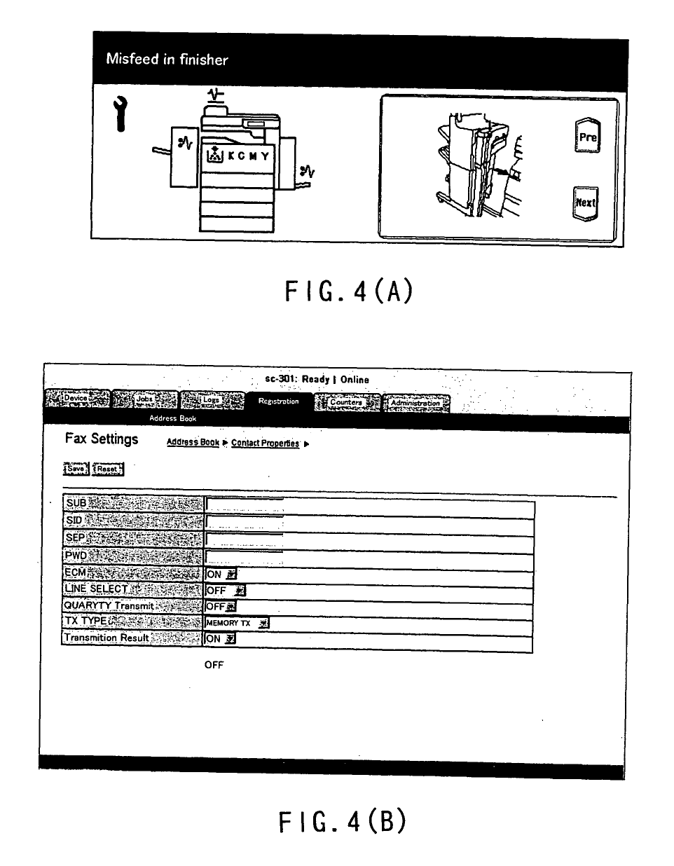

FIG. 2(A) shows a standby screen in the copy mode. FIG. 2(B) shows a screen displayed when the non-sort mode is selected in the copy mode shown in FIG. 2(A). FIG. 3(A) shows a screen in the FAX mode. FIG. 3(B) shows a screen displayed when an icon representing the ADVANCED function (i.e. extended function) is selected in the FAX mode shown in FIG. 3(A). FIG. 4(A) shows an alarm display screen. These FIGS. 2(A) to 4(A) show screen display on the standard panel 9.

The CPU 4 constantly performs a key matrix operation for a touch panel to detect whether or not a specific icon in the UI has been selected.

The standard panel control unit 10 generates a hierarchical menu predetermined by a program so as to correspond to each icon detected as stated above, and generates and transfers UI data to the standard panel 9.

It should be noted that a key matrix is provided for each of the standard panel 9 and the option panel 18. An operation performed with respect to the key matrix of the option image display unit 12 is controlled by the CPU 13 of the option image display unit 12 in the same way as the above, and a selected icon is detected.

The option image display unit 12 has a 256-shade color (8-bit) full VGA (640×480) display panel. However, the number of shades of gray, the size, etc. of the option display panel can be selected as desired. Thus, it is possible to select data to be installed in the option UI data 3 according to the specifications of the option panel used for expansion and to download the selected data through the download IF 7.

In the present invention, when the option image display unit 12 is attached, the standard panel 9 is removed. A screen displayed on the option panel 18 in a standby state when the option image display unit 12 is attached contains a default screen for each function (copy, PRT, FAX, and scanner) as in the case of the above-described standard panel. When the user wants to use a specific function displayed in the UI screen, he or she selects an icon representing the desired function. FIG. 4(B) shows an example of a display screen on the option panel 18.

Next, methods of changing languages used on the option panel 18 will be described in detail.

Methods of changing languages used for screen display on the option panel 18 include a method of temporarily changing languages by a user's operation, and a default language changing method for use by a serviceman during maintenance and inspection operations.

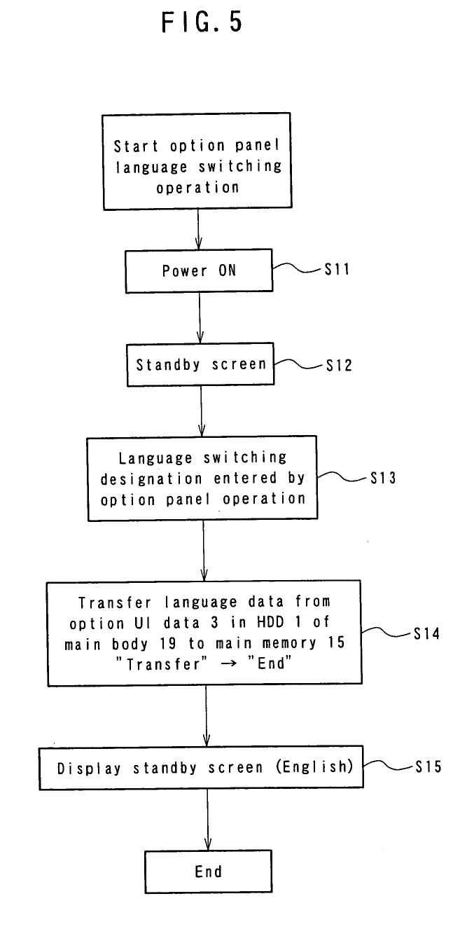

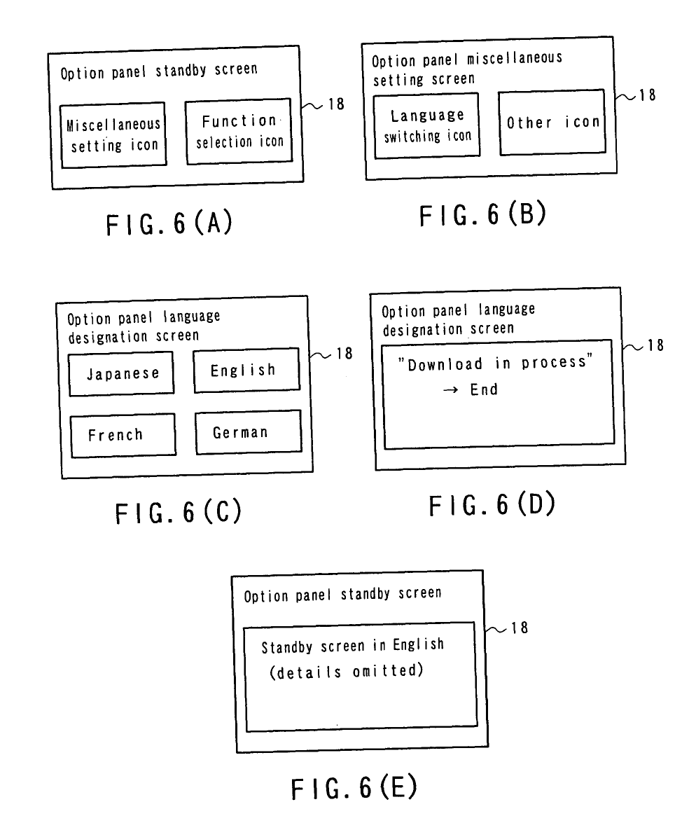

First, the method of temporarily changing languages by a user's operation will be described by using FIGS. 5 and 6(A) to 6(E). FIG. 5 is a flowchart for describing the flow of operation.

The power to the MFP main body 19 and the option image display unit 12 is turned ON (S11).

Next, a miscellaneous setting icon in a standby screen such as that shown in FIG. 6(A), which is displayed on the option panel 18, is selected (S12). Consequently, the screen display is switched to a miscellaneous setting screen such as that shown in FIG. 6(B).

Subsequently, a language switching icon in the above-described miscellaneous setting screen is selected. Consequently, the screen display is switched to a language designation screen such as that shown in FIG. 6(C). Then, any one of languages displayed in the language designation screen is selected (S13). It is herein assumed that English is selected, by way of example.

In response to the operation at the above-described step 13, UI data corresponding to the selected language (English) is selected from the option UI data 3 stored in the HDD 1 of the MFP main body 19 and transferred to the main memory 15 (S14). The way in which the selected UI data is being transferred is displayed as shown in FIG. 6(D).

As the result of the operations carried out at the above-described steps 11 to 14, the language is switched to English, and screen display as shown in FIG. 6(E) appears (S15). A detailed description of the display screen in English is herein omitted.

It should be noted that the UI data concerning the language switched to the selected one is temporarily stored in the main memory of the option panel. Therefore, when the power to the option image display unit 12 is turned OFF, the language for the display screen returns to the initial default language.

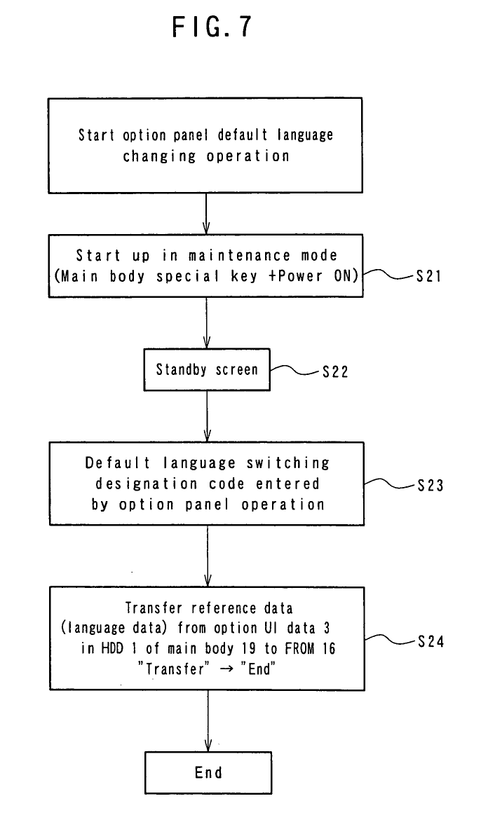

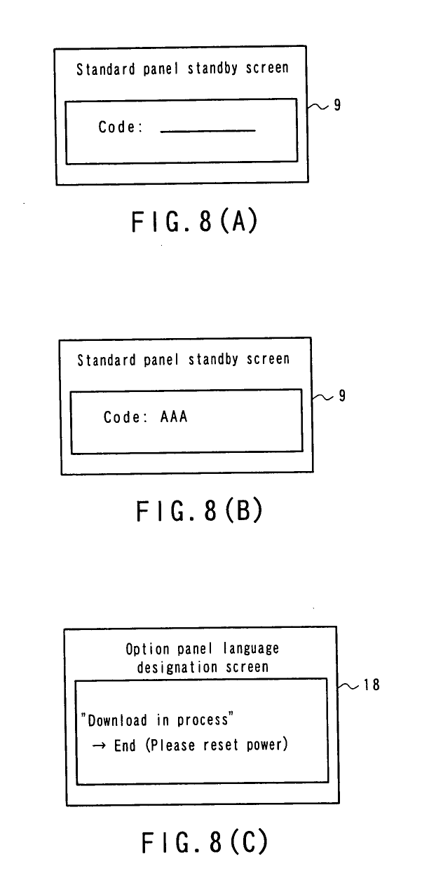

Next, the default language changing method for use by a serviceman during maintenance and inspection operations will be described by using FIGS. 7 and 8(A) to 8(C). FIG. 7 is a flowchart for describing the flow of operation.

The power to the MFP main body 19 and the option image display unit 12 is turned ON. At this time, the serviceman turns ON the power while pushing a special key (not shown) provided on the MFP main body, thereby starting the system in the maintenance mode (S21).

When the system is started in the maintenance mode, a standby screen such as that shown in FIG. 8(A) is displayed on the standard panel 9 of the MFP main body 19 (S22).

Subsequently, as shown in FIG. 8(B), a default language switching designation code is entered in the standby screen displayed on the standard panel 9 (S23).

In response to the entry of the default language switching designation code and the depression of a start button (not shown), UI data corresponding to the language selected by the code entry is selected from the option UI data 3 stored in the HDD 1 of the MFP main body 19, and the selected UI data is transferred to the FROM 16 (S24). FIG. 8(C) shows the condition of the screen display on the option panel 18 when the transfer of the UI data has been completed.

As the result of the operations carried out at the above-described S21 to S24, the default language is switched to the selected language, and screen display using the selected language appears. It should be noted that unlike in the case of the above-described changing method executed at S11 to S15, the changed default language is maintained as the initial default language even if the power to the option panel 12 is turned OFF.

Although in this embodiment the power to the option image display unit 12 turns ON in interlocking relation to the power to the MFP main body 19, it should be noted that the present invention is not necessarily limited to the described arrangement. The option image display unit 12 and the MFP main body 19 may have respective power supplies that are independent of each other.

Further, in this embodiment, when UI data that has been stored in the HDD 1 is transmitted from the MFP main body 19 to the option image display unit 12, it is temporarily stored in the FROM and then used for image display on the option panel. However, the present invention is not necessarily limited to the described arrangement. The system may be arranged to display an image on the option panel by directly using UI data transmitted from the MFP main body 19 to the option image display unit 12 without temporarily storing it in the FROM.

With the above-described arrangement, even in the case of performing image display on the option image display unit based on an enormous amount of UI data (data serving as image information) for a plurality of languages, a storage area of large capacity need not be provided on the option image display unit side because the UI data can be stored in the image information storage unit provided outside the option image display unit. Further, even when a storage area is needed on the option image display unit side, it is only necessary to provide a storage area (e.g. an FROM) having a minimum required capacity. Thus, the arrangement according to the present invention has the effect of achieving a cost reduction.

Consequently, it is possible to reduce the required capacity of an FROM provided on the option image display unit side in a multi-function peripheral apparatus that can be additionally equipped with an option image display unit according to need.

Similar advantageous effects can also be obtained by processing image information in the above-described multi-function peripheral main body according to an image information processing method having the step of reading image information from an image information storage unit for storing at least image information to be used for image display on the option image display unit and the step of transmitting the read image information to the option image display unit. The advantageous effects are also obtainable with an image information processing program that instructs a CPU (i.e. the CPU 4 as a computer) to execute processing similar to that carried out by the above-described image information processing method.

It is a matter of course that similar advantageous effects can also be obtained by processing image information in the above-described option image display unit according to an image information processing method having the step of reading image information stored in an image information storage unit provided outside the option image display unit and the step of allowing an option-side image display unit to perform image display based on the read image information. The advantageous effects are also obtainable with an image information processing program that instructs a CPU (i.e. the CPU 13 as a computer) to execute processing similar to that carried out by the above-described image information processing method.

As has been detailed above, the present invention provides a multi-function peripheral system, a multi-function peripheral apparatus, an option image display unit, an image information processing method, and an image information processing program, which allow a reduction in the capacity required for an image information storage unit provided on the option image display unit side in a multi-function peripheral system that can be additionally equipped with an option panel according to need.

What is claimed is:

1. A multi-function peripheral system having a multi-function peripheral main body with a main body-side image display unit for performing image display, and an option image display unit for performing image display that is capable of being detachably attached to the multi-function peripheral main body, said multi-function peripheral system comprising:
an image information storage unit provided outside said option image display unit to store at least image information to be used for image display on said option image display unit;
wherein said option image display unit has an option-side image display unit for performing image display, and a control unit for controlling said option-side image display unit to perform image display based on the image information stored in said image information storage unit.

2. A multi-function peripheral system according to claim 1, wherein said option image display unit has an option-side storage unit for storing some information obtained from information stored in said image information storage unit and displayable by said option image display unit.

3. A multi-function peripheral system according to claim 1, wherein said image information storage unit stores image information to be used for image display on said main body-side image display unit.

4. A multi-function peripheral system according to claim 1, wherein said image information storage unit is provided in said multi-function peripheral main body.

5. A multi-function peripheral system according to claim 1, wherein said image information storage unit comprises a hard disk.

6. A multi-function peripheral system according to claim 2, wherein said option-side storage unit comprises an FROM.

7. A multi-function peripheral system according to claim 1, wherein said image information storage unit is provided in an external device connected to said multi-function peripheral main body through a network.

8. A multi-function peripheral system according to claim 1, wherein the image information stored in said image information storage unit can be changed through a network.

9. A multi-function peripheral apparatus having a main body-side image display unit for performing image display and capable of being detachably equipped with an option image display unit for performing image display, said multi-function peripheral apparatus comprising:
an image information storage unit for storing at least image information usable for image display on said option image display unit; and
a main body-side control unit for transmitting image information concerning a selected part of the image information stored in said image information storage unit to said option image display unit.

10. A multi-function peripheral apparatus according to claim 9, wherein said image information storage unit stores image information to be used for image display on said main body-side image display unit.

11. A multi-function peripheral apparatus according to claim 9, wherein the image information stored in said image information storage unit can be changed through a network.

12. An option image display unit for performing image display that is capable of being detachably attached to a multi-function peripheral main body having a main body-side image display unit for performing image display, said option image display unit comprising:
an option-side image display unit for performing image display; and
a control unit for controlling said option-side image display unit to perform image display based on image information stored in an image information storage unit provided outside said option image display unit.

13. An option image display unit according to claim 12, further comprising:
an option-side storage unit for storing some information obtained from information stored in said image information storage unit and displayable by said option image display unit.

14. An option image display unit according to claim 12, wherein said image information storage unit stores image information to be used for image display on said main body-side image display unit.

15. An option image display unit according to claim 12, wherein said image information storage unit is provided in said multi-function peripheral main body.

16. An option image display unit according to claim 12, wherein said image information storage unit is provided in an external device connected to said multi-function peripheral main body through a network.

17. An option image display unit according to claim 12, wherein the image information stored in said image information storage unit can be changed through a network.

18. An image information processing method for processing image information in a multi-function peripheral apparatus including a multi-function peripheral main body having a main body-side image display unit for performing image display, and an option image display unit for performing image display that is capable of being detachably attached to said multi-function peripheral main body, said image information processing method comprising:
an image information selectively designating step of selectively designating some image information to be used in said option image display unit from an image information storage unit for storing at least image information usable for image display on said option image display unit;
a read step of reading the image information selectively designated by said image information selectively designating step; and
a step of transmitting the image information read in said read step to said option image display unit.

19. An image information processing program executable by a computer for processing image information in a multi-function peripheral apparatus including a multi-function peripheral main body having a main body-side image display unit for performing image display, and an option image display unit for performing image display that is capable of being detachably attached to said multi-function peripheral main body, said image information processing program comprising:
an image information selectively designating step of selectively designating some image information to be used in said option image display unit from an image information storage unit for storing at least image information usable for image display on said option image display unit;
a read step of reading the image information selectively designated by said image information selectively designating step; and
a transmission step of transmitting the image information read in said read step to said option image display unit;
said program instructing the computer to execute said image information selectively designating step, read step and transmission step.
